(19) United States
(12) Patent Application Publication
(10) Pub. No.: US 2011/0155890 A1
(43) Pub. Date: Jun. 30, 2011

(54) SOLID-STATE IMAGING DEVICE

(75) Inventors: Yoshitaka Egawa, Kanagawa (JP); Yoshinori Iida, Tokyo (JP)

(73) Assignee: KABUSHIKI KAISHA TOSHIBA, Tokyo (JP)

(21) Appl. No.: 12/958,873

(22) Filed: Dec. 2, 2010

(30) Foreign Application Priority Data
Dec. 25, 2009 (JP) 2009-294486

(51) Int. Cl. H01L 27/146

(52) U.S. Cl. 250/208.1

(57) ABSTRACT

According to one embodiments, a pixel array unit in which pixels PC are arranged in a matrix manner, a sample-and-hold signal conversion circuit that detects a signal component of each of the pixels PC in a CDS, and a timing control circuit that controls to sample a reference level of an analog CDS after a reference level of a digital CDS is converted into a digital value are included.

### CROSS-REFERENCE TO RELATED APPLICATIONS

This application is based upon and claims the benefit of priority from the prior Japanese Patent Application No. 2009-294486, filed on Dec. 25, 2009; the entire contents of

### FIELD

The present embodiments typically relate to a solid-state imaging device.

### BACKGROUND

In a CMOS image sensor, a signal from each pixel is read out by a source follower circuit via a vertical signal line, and detection of a signal component is performed in an analog CDS (Correlated Double Sampling) for reducing an RTS noise and a 1/f noise of a pixel.

Moreover, when a digital sampling of a signal from each pixel is performed, detection of a signal component is performed in a digital CDS for suppressing a vertical stripe due to variation of a threshold of a comparator in each column from occurring on a screen.

However, with this method, because the analog CDS and the digital CDS are performed simultaneously, the interval of the analog CDS becomes long. Therefore, the RTS noise and the 1/f noise that are superimposed on a pixel output signal after sampling a reference level increases, so that a problem arises in that an S/N ratio degrades.

### BRIEF DESCRIPTION OF THE DRAWINGS

FIG. 1 is a block diagram illustrating a schematic configuration of a solid-state imaging device according to a first embodiment of the present invention;

FIG. 2 is a circuit diagram illustrating a schematic configuration of a column amplifier, an RTS noise reduction circuit, and a column AD converter applied to the solid-state imaging device shown in FIG. 1;

FIG. 3 is a timing chart illustrating a signal waveform of each unit at the time of readout of the solid-state imaging device according to the first embodiment of the present invention;

FIG. 4 is a diagram illustrating a relationship between an RTS noise and a CDS interval for each pixel index of the solid-state imaging device shown in FIG. 1;

FIG. 5 is a diagram illustrating a CDS interval independency of the RTS noise of the solid-state imaging device shown in FIG. 1;

FIG. 6 is a circuit diagram illustrating a schematic configuration of an RTS noise reduction circuit and a column AD converter applied to a solid-state imaging device according to a second embodiment of the present invention;

FIG. 7 is timing chart illustrating a signal waveform of each unit at the time of readout of the solid-state imaging device according to the second embodiment of the present invention;

FIG. 8 is a circuit diagram illustrating a schematic configuration of an RTS noise reduction circuit and a column AD converter applied to a solid-state imaging device according to a third embodiment of the present invention;

FIG. 9 is timing chart illustrating a signal waveform of each unit at the time of readout of the solid-state imaging device according to the third embodiment of the present invention;

FIG. 10 is a circuit diagram illustrating a schematic configuration of an RTS noise reduction circuit and a column AD converter applied to a solid-state imaging device according to a fourth embodiment of the present invention;

FIG. 11 is timing chart illustrating a signal waveform of each unit at the time of readout of the solid-state imaging device according to the fourth embodiment of the present invention;

FIG. 12 is a circuit diagram illustrating a schematic configuration of an RTS noise reduction circuit and a column AD converter applied to a solid-state imaging device according to a fifth embodiment of the present invention; and

FIG. 13 is timing chart illustrating a signal waveform of each unit at the time of readout of the solid-state imaging device according to the fifth embodiment of the present invention.

### DETAILED DESCRIPTION

In general, according to embodiments, a pixel array unit, a sample-and-hold signal conversion circuit, and a timing control circuit are included. In the pixel array unit, pixels are arranged in a matrix manner. The sample-and-hold signal conversion circuit detects a signal component of each pixel in a correlated double sampling (CDS). The timing control circuit controls to sample a reference level of an analog CDS after a reference level of a digital CDS is converted into a digital value.

A solid-state imaging device according to the embodiments of the present invention will be explained below with reference to the accompanying drawings. The present invention is not limited to these embodiments.

### First Embodiment

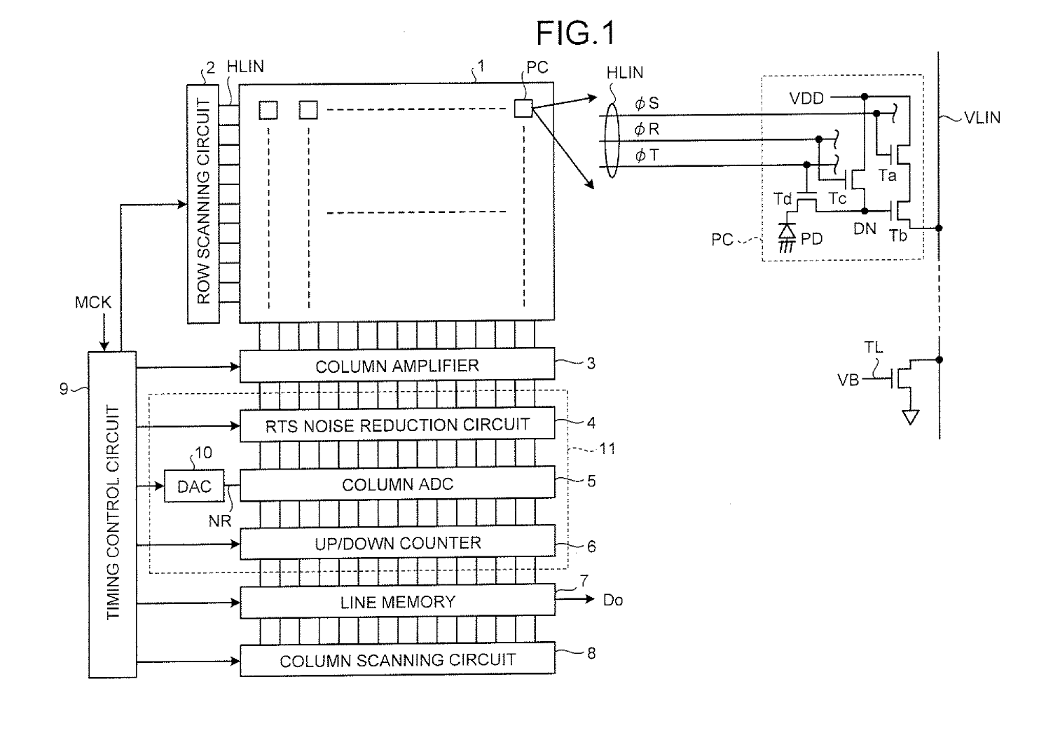

FIG. 1 is a block diagram illustrating a schematic configuration of a solid-state imaging device according to the first embodiment of the present invention.

In FIG. 1, the solid-state imaging device includes a pixel array unit 1 in which pixel PCs that accumulate photoelectrically converted charges are arranged in a matrix manner in a row direction and a column direction, a row scanning circuit 2 that scans the pixel PCs to be readout targets in a vertical direction, a column amplifier 3 that amplifies a signal read out from the pixel PC for each column, a sample-and-hold signal conversion circuit 11 that detects a signal component of each pixel PC in a CDS, a line memory 7 that holds a signal detected in the sample-and-hold signal conversion circuit 11 for each horizontal line, a column scanning circuit 8 that scans the pixel PCs to be the readout targets in a horizontal direction, and a timing control circuit 9 that controls timing of readout and accumulation of each pixel PC.

In the pixel array unit 1, horizontal control lines HLIN that perform a readout control of the pixel PCs are provided in the row direction, and vertical control lines VLIN that transmit signals read out from the pixel PCs are provided in the column direction. The horizontal control line HLIN can transmit a readout signal ΦT, a reset signal (DR, and a row select signal ΦS to the pixel PC.

Moreover, in the pixel. PC, a photodiode PD, a row select transistor Ta, an amplifier transistor Tb, a reset transistor Tc, and a readout transistor Td are provided.

In the pixel PC, the source of the readout transistor Td is connected to the photodiode PD, and the readout signal ΦT is input to the gate of the readout transistor Td. Moreover, the source of the reset transistor Tc is connected to the drain of the readout transistor Td, the reset signal ΦR is input to the gate of the reset transistor Tc, and the drain of the reset transistor Tc is connected to a power supply potential VDD. Furthermore, the row select signal ΦS is input to the gate of the row select transistor Ta, and the drain of the row select transistor Ta is connected to the power supply potential VDD. Moreover, the source of the amplifier transistor Tb is connected to the vertical signal line VLIN, the gate of the amplifier transistor Tb is connected to the drain of the readout transistor Td, and the drain of the amplifier transistor Tb is connected to the source of the row select transistor Ta.

A detection node DN is formed at a connection point of the gate of the amplifier transistor Tb and the drain of the readout transistor Td. Moreover, a drain of a load transistor TL is connected to the vertical control line VLIN, and a bias signal VB is input to the gate of the load transistor TL. The load transistor TL configures a source follower to be able to perform a constant current operation.

Moreover, the sample-and-hold signal conversion circuit 11 includes an RTS noise reduction circuit 4 that reduces an RTS noise that is superimposed on the readout signal from the pixel PC, a column AD converter 5 that compares the readout signal from the pixel PC with a reference signal NR, an up/down counter 6 that calculates a difference between the reference level of the CDS and a readout level by performing an up-counting and a down-counting based on the comparison result of the column AD converter 5, and a DA converter 10 that outputs the reference signal NR. The DA converter 10 can output a triangle wave as the reference signal NR at the time of the up-counting and the down-counting by the up/down counter 6.

The sample-and-hold signal conversion circuit 11 can detect only a signal component read out from the pixel PC in the digital CDS and the analog CDS.

In the digital CDS, the reference level for comparing a signal read out from the pixel PC with the reference signal NR can be set. Then, the reference level of the digital CDS is subtracted from a readout level of a signal component read out from the pixel PC, so that a difference (offset error) between inputs of a comparator circuit can be suppressed, whereby a vertical stripe noise that is generated on a screen can be suppressed.

In the analog CDS, the reference level of the analog CDS can be set based on a signal in a reset level after the detection node DN of the pixel PC is reset. Then, the reference level of the analog CDS is subtracted from a readout level of a signal component read out from the pixel PC, so that a KTC noise of the detection node DN due to a reset operation can be suppressed. Moreover, the RTS noise and a 1/f noise can be reduced by shortening the interval of this analog CDS.

Moreover, the timing control circuit 9 can control to perform sampling of the reference level of the analog CDS after the reference level of the digital CDS is converted into a digital value. A master clock MCK is input to the timing control circuit 9.

When the readout signal ΦT is in a low level, the row select transistor Ta becomes an off state and a source follower operation is not performed, so that a signal is not output to the vertical control line VLIN. At this time, when the readout signal ΦT becomes a high level, the readout transistor Td of the pixel PC is turned on and charges accumulated in the photodiode PD are transferred to the detection node DN. Immediately thereafter, accumulation of effective signal charges is started in the photodiode PD. Thereafter, when the reset signal ΦR becomes a high level, the reset transistor Tc is turned on and the charges read out to the detection node DN are reset.

Next, when the row select signal ΦS becomes a high level, the row select transistor Ta of the pixel PC is turned on. Then, when the reset signal ΦR becomes a high level in a state where the row select transistor Ta of the pixel PC is on, the reset transistor Tc is turned on and a voltage in accordance with the reset level of the detection node DN is applied to the gate of the amplifier transistor Tb. Because the source follower is composed of the amplifier transistor Tb of the pixel PC and the load transistor TL, the voltage of the vertical control line VLIN follows the voltage applied to the gate of the amplifier transistor Tb.

Then, after the voltage of the vertical control line VLIN at this time is amplified in the column amplifier 3, the voltage is sent to the RTS noise reduction circuit 4. Moreover, at this time, the output level of the comparator that performs comparison with the reference signal NR for each column is sent from the column AD converter 5 to the RTS noise reduction circuit 4. Then, the difference between the reset level of the detection node DN and the output level of the comparator is held in the RTS noise reduction circuit 4.

Then, the signal held in the RTS noise reduction circuit 4 at this time is sent to the column AD converter 5, and when a triangle wave is applied as the reference signal NR, the down-counting is performed until the signal held in the RTS noise reduction circuit 4 at this time matches the reference signal NR, so that the signal held in the RTS noise reduction circuit 4 at this time is converted into a digital value.

Then, after the signal held in the RTS noise reduction circuit 4 at this time is converted into the digital value, in the RTS noise reduction circuit 4, the voltage level after the charges accumulated in the pixel PC are reset is sampled again as the reference level of the analog CDS and is held.

Next, after the reference level of the analog CDS is sampled in the RTS noise reduction circuit 4, when the readout signal ΦT becomes a high level, the readout transistor Td is turned on and charges accumulated in the photodiode PD are transferred to the detection node DN. Then, a voltage in accordance with the charge amount transferred to the detection node DN is applied to the gate of the amplifier transistor Tb. Because the source follower is composed of the amplifier transistor Tb of the pixel PC and the load transistor TL, the voltage of the vertical control line VLIN follows the voltage applied to the gate of the amplifier transistor Tb.

Then, after the voltage of the vertical control line VLIN at this time is amplified in the column amplifier 3, the voltage is sent to the RTS noise reduction circuit 4 and the signal level of the detection node DN and the reset level of the detection node DN are held in the RTS noise reduction circuit 4.

Then, the signal held in the RTS noise reduction circuit 4 at this time is sent to the column AD converter 5, and when a triangle wave is applied as the reference signal NR, the up-counting is performed until the signal held in the RTS noise reduction circuit 4 at this time matches the reference signal NR. Then, the signal from which the signal of the last time at the down-counting is subtracted is output as a digital value. Then, data for one line output from the up/down counter 6 is held in the line memory 7 and is output as output data Do for one line.

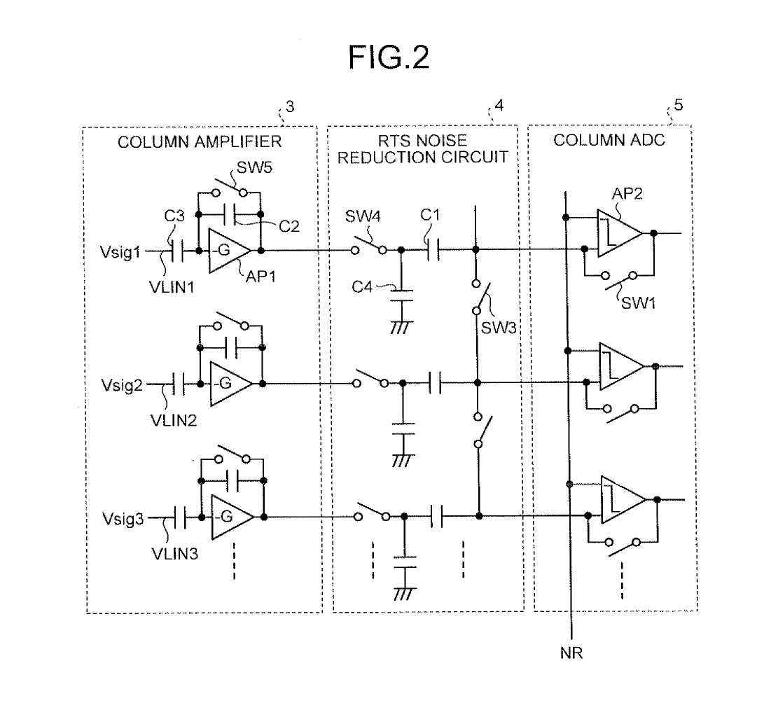

FIG. 2 is a circuit diagram illustrating a schematic configuration of the column amplifier 3, the RTS noise reduction circuit 4, and the column AD converter 5 applied to the solid-state imaging device shown in FIG. 1.

In FIG. 2, an amplifier AP1 is provided for each column in the column amplifier 3, capacitors C1 and C4 are provided for each column in the RTS noise reduction circuit 4, and a comparator AP 2 is provided for each column in the column AD converter 5. Readout signals Vsig1 to Vsig3 read out from the pixel PCs for vertical signal lines VLIN1 to VLIN3, respectively, are input to the column amplifier 3.

A capacitor C3 is connected to the input terminal of the amplifier AP1, and a capacitor C2 is connected between the input terminal and the output terminal of the amplifier AP1. Moreover, a switch SW5 is connected in parallel with the capacitor C2. Furthermore, the output terminal of the amplifier AP1 is connected to one ends of the capacitors C1 and C4 via a switch SW4, the other end of the capacitor C1 is connected to one input terminal of the comparator AP2, and the other end of the capacitor C4 is grounded.

The reference signal NR is input to the other input terminal of the comparator AP2, and a switch SW1 is connected between one input terminal and the output terminal of the comparator AP2. Moreover, one input terminals of the comparators AP2 are connected with each other between columns via switches SW3.

A switched-capacitor-type inverting amplifier capable of controlling a gain G with a capacitor ratio can be used as the column amplifier 3. This gain G can be calculated by C3/C2. For example, when C3=0.05 pF and C2=0.4 pF, the gain G is eight times. As the switches SW3 and SW4 of the RTS noise reduction circuit 4, an N-type MOS transistor, a P-type MOS transistor, or a CMOS type transistor in which N-type and P-type are combined can be used. As the capacitors C1 and C4, a capacitor of 0.1 pF or more can be used. As the column ADC 5, a difference amplifier having a high gain G can be used.

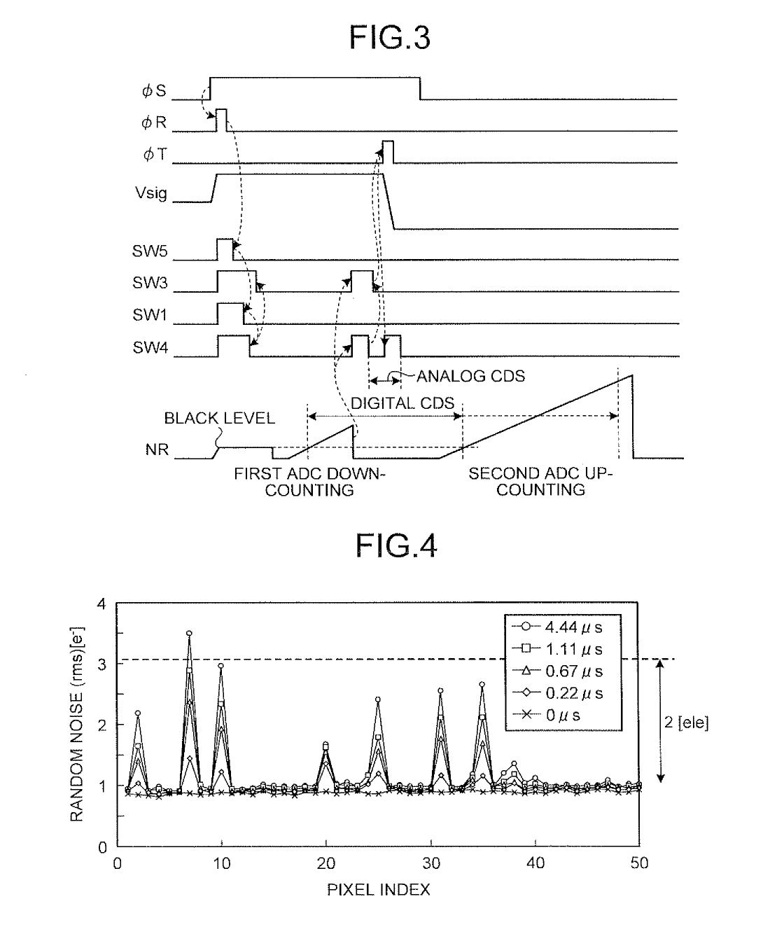

FIG. 3 is a timing chart illustrating a signal waveform of each unit at the time of readout of the solid-state imaging device according to the first embodiment of the present invention.

In FIG. 3, the row select signal ΦS is set to a high level, so that the source follower operation for reading out a signal from the pixel PC is performed. When the reset signal ΦR becomes a high level and then a low level, the reset transistor Tc is turned on and then turned off and a signal in the reset level of the pixel PC is output to the vertical control line VLIN. When this signal in the reset level is output to the vertical control line VLIN, if the switch SW5 is turned on/off, the input voltage of the column amplifier 3 is clamped to the output voltage and an operation point is set. At this time, the difference in voltage from the vertical control line VLIN is held in the capacitor C3 and the input voltage of the column amplifier 3 is zeroed out.

Thereafter, when the input voltage of the column amplifier 3 changes via the capacitor C3, a voltage is fed back from the capacitor C2 so that the input voltage becomes a zero voltage. Consequently, a signal voltage that is inverted and amplified by the capacitor ratio C3/C2 is output from the column amplifier 3.

The switches SW1, SW3, and SW4 are turned on when the signal in the reset level is output, so that the output voltage of the column amplifier 3 is applied to the capacitors C1 and C4, one input terminal and the output terminal of the comparator AP2 are short-circuited, and one input terminals of the comparators AP2 are short-circuited between the columns. Then, the switch SW1 is turned off.

Then, the switch SW4 is turned off. The reset level is held in the capacitor C4. The signal level held in the capacitor C4 varies between the columns. On the other hand, on the switch SW3 side via the capacitor C1, the switches SW3 are on, so that a new averaged consistent reference level is generated by sharing the potential of one input terminals of the comparators AP2 between the columns. The variation of the capacitor C4 between the columns is held in the capacitor C1 of each column as the difference. With the new reference level that is averaged by the switches SW3, the difference (offset error) between one reference signal NR of the comparator AP2 and the zero level becomes large; however, at the time of capturing a signal before the second ADC operation, the same operation is performed, so that the offset error can be suppressed in the digital CDS by a subtraction operation with the digital signal subjected to the first ADC. Consequently, occurrence of a vertical streak on a screen can be suppressed.

Next, the reference signal NR and the output level of the RTS noise reduction circuit 4 are compared in the comparator AP2 while changing the reference signal NR on a positive side. Then, in the up/down counter 6, the down-counting is performed until the reference signal NR and the output level of the RTS noise reduction circuit 4 match, and the count value thereof is held as the reference level of the digital CDS of each column. After this first operation of the up/down counter 6 is finished, the switches SW3 and SW4 are turned on again. Then, the switch SW4 is turned off and the capacitor C4 is caused to capture the signal level of the source follower amplified in the column amplifier 3 at the time when the signal in the reset level is output from the pixel PC. The signal level held in the capacitor C4 varies between the columns. On the other hand, on the switch SW3 side via the capacitor C1, the switch SW3 is on, so that the variation between the columns of the capacitor C4 that generates the averaged consistent reference level is held as the difference in the capacitor C1 of each column. At this time, variation due to a 1/f (RTS) noise component occurs in the signal captured at the second falling edge of the switch SW4 because of the elapse of time from the signal captured at the first falling edge. However, this variation is suppressed by holding a new differential signal in the capacitor C1.

Then, the readout signal. ΦT is applied to the readout transistor Td after the switch SW3 is turned off. When the readout signal ΦT becomes a high level, the readout transistor Td is turned on and the read out signal level of the pixel PC is output to the vertical control line VLIN. The switch SW4 is turned on at the time when this read out signal level is output to the vertical control line VLIN, so that the output voltage of the column amplifier 3 is applied to the capacitors C1 and C4. Thereafter, the switch SW4 is turned off, so that the signal level read out from the pixel PC is held in the capacitor C4.

With this on/off operation of the switches SW3 and SW4, the actual interval of the analog CDS can be a period from the second off-time of the switch SW4 to the third off-time of the switch SW4 at the time when the row select signal ΦS is in a high level. Therefore, the actual interval of the analog CDS can be made to about 0.5 uS in the first embodiment, which is about 3 uS in Non-patent Document 1, i.e., the interval can be shortened to ⅙ compared to the conventional technology.

Next, the reference signal NR and the output level of the RTS noise reduction circuit 4 are compared in the comparator AP2 while changing the reference signal NR on a positive side. Then, in the up/down counter 6, the up-counting is performed until the reference signal NR and the output level of the RTS noise reduction circuit 4 match, and the count value thereof is output to the line memory 7 as a signal component detected in the CDS.

In the digital CDS, a vertical stripe noise that is generated on a screen can be suppressed mainly by cancelling a fixed error between inputs of each comparator circuit after the switch SW1 is turned off. Although a heat noise generated in a transistor at the moment of turning off the switches SW3 and SW4 is superimposed as the KTC noise, the noise level of the KTC noise can be made smaller than the signal level by amplifying the input signal in the column amplifier 3, so that the effect of the KTC noise can be reduced. Alternatively, the effect of the KTC noise can be reduced by making the capacitance value of the capacitors C1 and C4 large.

Moreover, the comparison operation by the column AD converter 5 and the readout operation of the line memory 7 can be performed in parallel by providing the line memory 7 after the up/down counter 6, so that speed of the CMOS sensor can be increased.

FIG. 4 is a diagram illustrating a relationship between the RTS noise and the CDS interval for each pixel index of the solid-state imaging device shown in FIG. 1.

FIG. 4 illustrates that when the CDS interval is 3 uS, the RTS noise of about two electrons (ele) occurs. Specially, this RTS noise causes a problem at the time of shooting with low illumination. This RTS noise becomes large as the CDS interval becomes long.

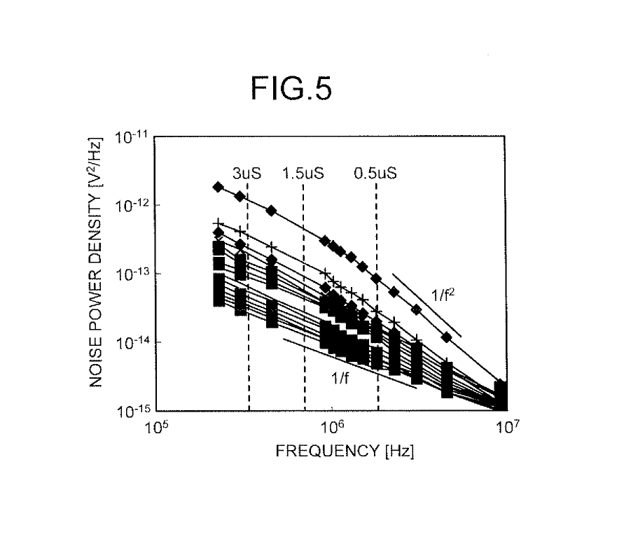

FIG. 5 is a diagram illustrating a CDS interval independency of the RTS noise of the solid-state imaging device shown in FIG. 1.

In FIG. 5, as the tile of the 1/f noise, the noise power of this RTS noise degrades 10 times when the frequency becomes 1/10. The noise of the tilt of 1/f² degrades 100 times when the frequency becomes 1/10. It is found from FIG. 5 that the RTS noise increases drastically when the frequency f is equal to or lower than 10 MHz. When the CDS interval is 3 uS, the noise power of 20 to 1000 times with respect to the noise of the heat noise (10⁻¹⁵[V²/Hz]) is generated. The noise of √(20)=4.5 times to √(1000)=32 times is generated in an effective voltage.

When the CDS interval becomes short from 3 uS to 0.5 uS, the 1/f noise can be estimated to be ⅓ in the effective voltage from the tilt, so that the 1/f noise can be reduced by ⅔=0.67 ele. Furthermore, the 1/f² noise can be significantly reduced to 1/9 in the effective voltage.

Typically, the KTC noise is generated at the time of the sample and hold operation of holding a signal in a capacitor via a resistor, and a generated voltage Vn thereof can be calculated by Vn=√(kT/C), in which k is Boltzmann constant, T is temperature, and C is a capacitance of a capacitor. When the capacitance value of the capacitor C is 0.1 pf, the KTC noise is 2.0 ele. When the gain of the column amplifier 3 is 10 times, the KTC noise can be made as small as 1/10, i.e., 0.2 ele, which is sufficiently small (under the condition in which a conversion gain in a detection unit of the pixel PC is set to 100 uV/ele).

### Second Embodiment

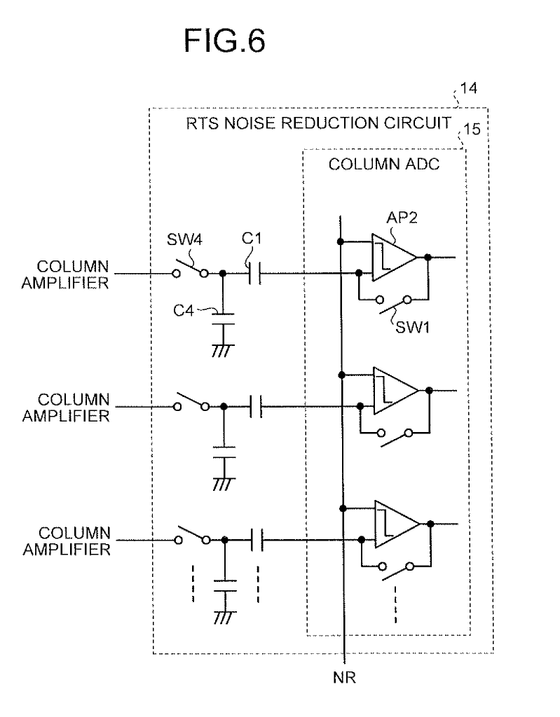

FIG. 6 is a circuit diagram illustrating a schematic configuration of an RTS noise reduction circuit 14 and a column AD converter 15 applied to a solid-state imaging device according to the second embodiment of the present invention.

In FIG. 6, this solid-state imaging device includes the RTS noise reduction circuit 14 instead of the RTS noise reduction circuit 4 and the column AD converter 5 in FIG. 1, and the RTS noise reduction circuit 14 includes the column AD converter 15. The RTS noise reduction circuit 14 is similar to the RTS noise reduction circuit 4 in FIG. 2 except that the switches SW3 in FIG. 2 are omitted and the column AD converter 15 is included. Moreover, the configuration of the column AD converter 15 is similar to the column AD converter 5 in FIG. 2.

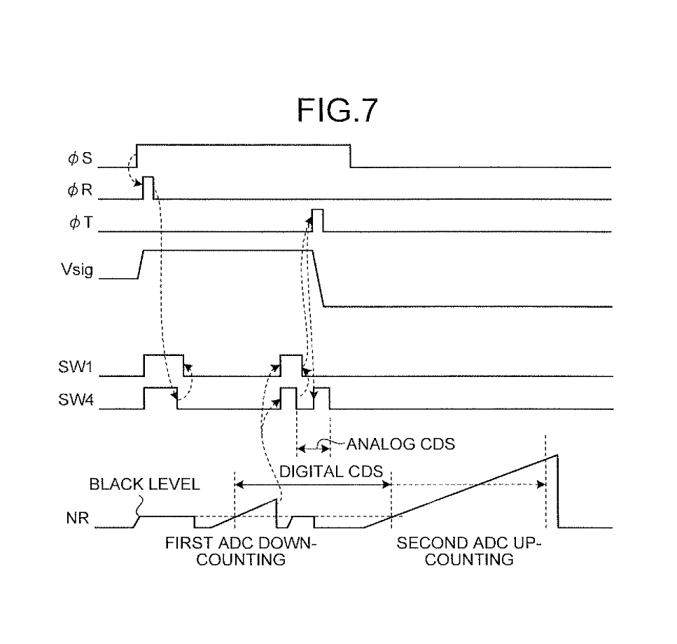

FIG. 7 is timing chart illustrating a signal waveform of each unit at the time of readout of the solid-state imaging device according to the second embodiment of the present invention.

In FIG. 7, in the method in FIG. 3, when the first operation of the up/down counter 6 is finished, the difference from the reference level obtained by averaging the 1/f (RTS) noise that changes in the pixel PC between the columns is held in the capacitor C1 again by turning on/off the switches SW3 and SW4 again, whereas in a method in FIG. 7, when the first operation of the up/down counter 6 is finished, the switches SW1 and SW4 are turned on/off to make a short-circuit between the input and the output of the comparator AP2 and hold the 1/f (RTS) noise that changes in the pixel PC in the capacitor C1 again.

The 1/f (RTS) noise variation of the source follower of the pixel PC is captured in the capacitor C1 again at the second off-time of the switch SW1 at the time when the row select signal ΦS is in a high level, so that the actual interval of the analog CDS can be a period from the second off-time of the switch SW4 to the third off-time of the switch SW4 at the time when the row select signal ΦS is in a high level. Therefore, the circuit configuration can be simplified for the omitted switches SW3 compared to the configuration of FIG. 2, and the reduction effect of the RTS noise equivalent to the first embodiment can be obtained.

### Third Embodiment

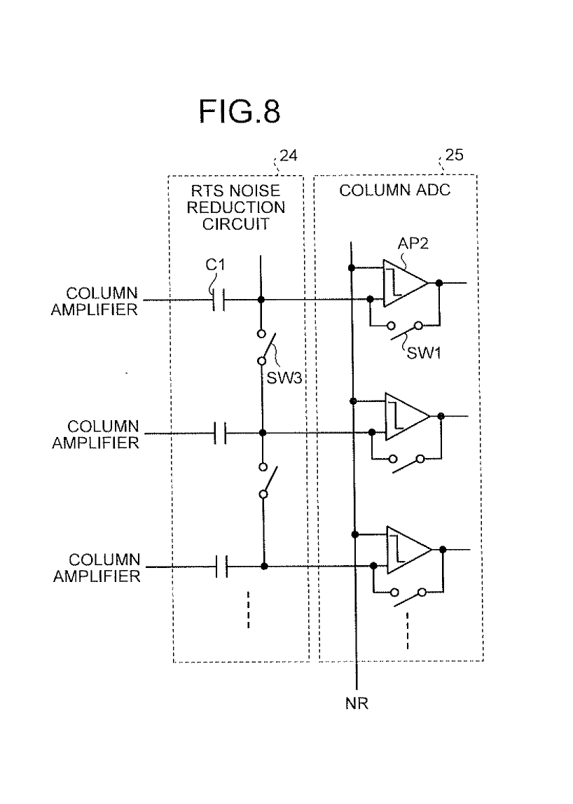

FIG. 8 is a circuit diagram illustrating a schematic configuration of an RTS noise reduction circuit 24 and a column AD converter 25 applied to a solid-state imaging device according to the third embodiment of the present invention.

In FIG. 8, this solid-state imaging device includes the RTS noise reduction circuit 24 and the column AD converter 25 instead of the RTS noise reduction circuit 4 and the column AD converter 5 in FIG. 1. The RTS noise reduction circuit 24 is similar to the RTS noise reduction circuit 4 in FIG. 2 except that the switches SW4 and the capacitors C4 in FIG. 2 are omitted. Moreover, the configuration of the column AD converter 25 is similar to the column AD converter 5 in FIG. 2.

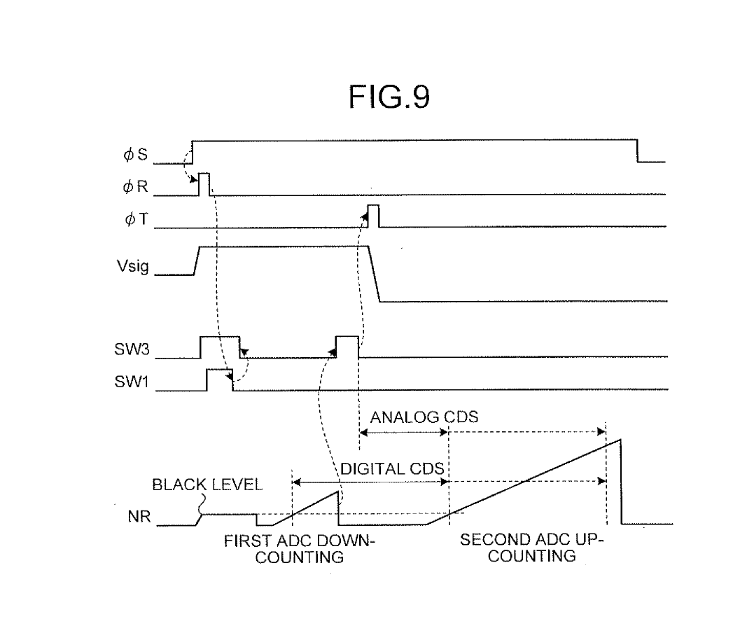

FIG. 9 is timing chart illustrating a signal waveform of each unit at the time of readout of the solid-state imaging device according to the third embodiment of the present invention.

In FIG. 9, in this third embodiment, the on/off operation of the switch SW3 is performed twice at the time when the row select signal ΦS is in a high level. The second on/off operation of the switch SW3 can be performed between the time after finishing the first operation of the up/down counter 6 and the time before the readout signal ΦT becomes a high level.

Then, signals on the output side of the capacitors C1 are averaged between the columns by the on operation of the switches SW3 at the time when the row select signal ΦS is in a high level. Therefore, the 1/f (RTS) noise of the source followers of the pixels PC is averaged and the reference level of the analog CDS is captured again in the capacitor C1 at the time when the switch SW3 is off. In the configuration of FIG. 8, the switch SW4 in FIG. 2 is not provided, so that the 1/f (RTS) noise of the source follower of the pixel PC cannot be captured again in the capacitor C1 after the readout signal ΦT becomes a high level. Therefore, the actual interval of the analog CDS is a period from the second off-time of the switch SW3 to the time when the output of the comparator AP2 is inverted in the second operation of the up/down counter 6 at the time when the row select signal ΦS is in a high level. In the period of low signal amount in which the RTS noise is noticeable, the CDS interval can be reduced to about ½ compared to the conventional method.

Thus, the circuit configuration is simplified for the switches SW4 and the capacitors C4 that are omitted compared to the configuration of FIG. 2, and the CDS interval is shortened from about 3 uS to about 1.5 uS, so that the 1/f noise component can be reduced to ½ as the noise power and 1/√(2)=1/1.4 as the effective value. The 1/f² component can be reduced to ½. If the signal amount increases, the CDS interval becomes long; however, a photon shot noise is noticeable, so that the RTS noise becomes less noticeable.

### Fourth Embodiment

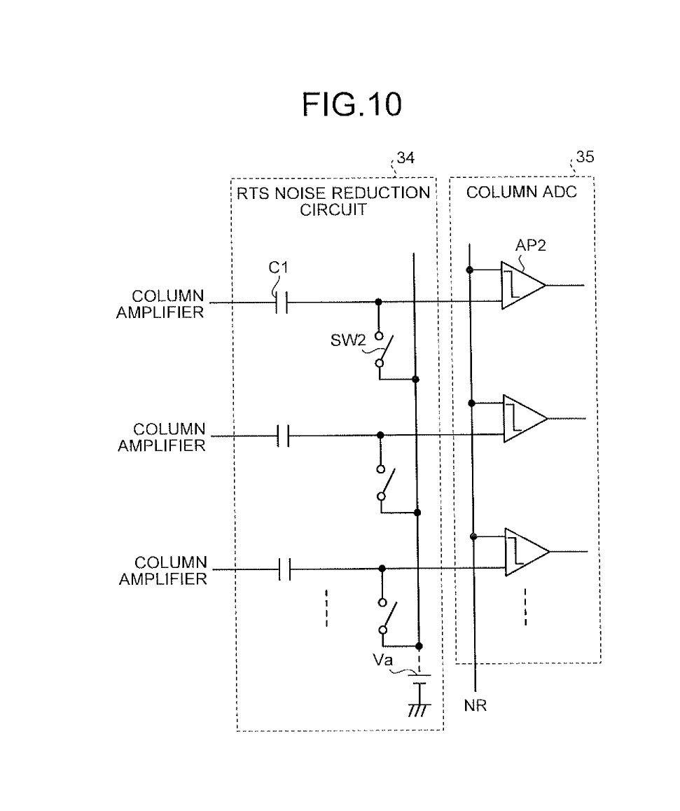

FIG. 10 is a circuit diagram illustrating a schematic configuration of an RTS noise reduction circuit 34 and a column AD converter 35 applied to a solid-state imaging device according to the fourth embodiment of the present invention.

In FIG. 10, this solid-state imaging device includes the RTS noise reduction circuit 34 and the column AD converter 35 instead of the RTS noise reduction circuit 4 and the column AD converter 5 in FIG. 1. The RTS noise reduction circuit 34 is similar to the RTS noise reduction circuit 4 in FIG. 2 except that the switches SW4 and the capacitors C4 in FIG. 2 are omitted and the switches SW2 are provided instead of the switches SW3. Moreover, the column AD converter 35 is similar to the column AD converter 5 in FIG. 2 except that the switches SW1 are omitted. The switch SW2 is inserted between one input terminal of the comparator AP2 and a clamp power supply Va for each column.

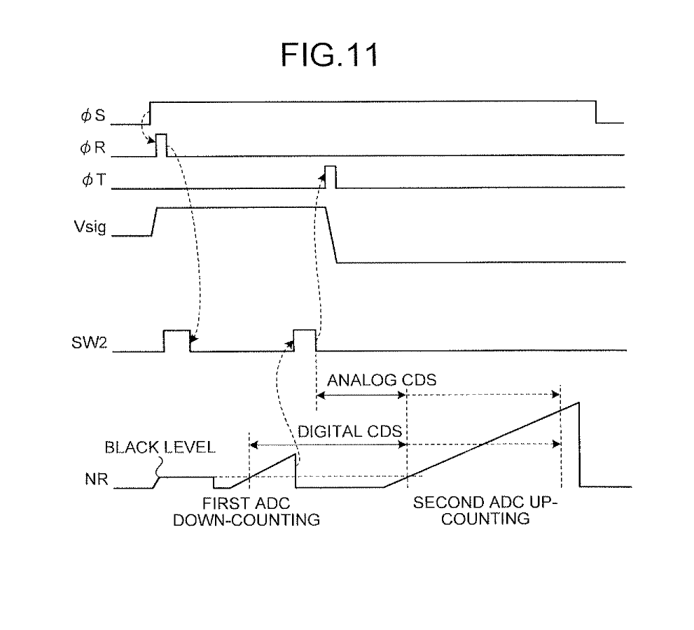

FIG. 11 is timing chart illustrating a signal waveform of each unit at the time of readout of the solid-state imaging device according to the fourth embodiment of the present invention.

In FIG. 11, in this fourth embodiment, the on/off operation of the switch SW2 is performed twice at the time when the row select signal ΦS is in a high level. The second on/off operation of the switch SW2 can be performed between the time after finishing the first operation of the up/down counter 6 and the time before the readout signal ΦT becomes a high level.

Then, the 1/f (RTS) noise of the source follower of the pixel PC is captured again in the capacitor C1 by the second on operation of the switch SW2 at the time when the row select signal ΦS is in a high level, and the reduction effect of the RTS noise equivalent to the third embodiment can be obtained. The actual interval of the analog CDS is a period from the second off-time of the switch SW2 to the time when the output of the comparator AP2 is inverted in the second operation of the up/down counter 6 at the time when the row select signal ΦS is in a high level. In the period of low signal amount in which the RTS noise is noticeable, the CDS interval can be reduced to about ½ compared to the conventional method.

### Fifth Embodiment

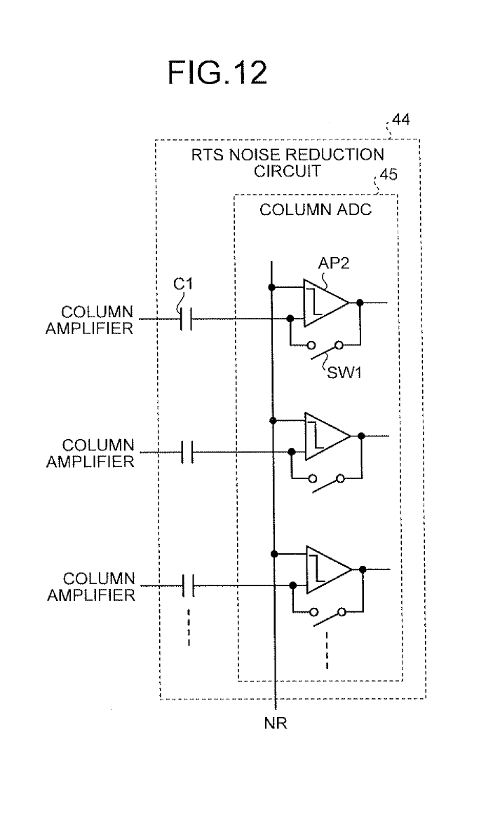

FIG. 12 is a circuit diagram illustrating a schematic configuration of an RTS noise reduction circuit 44 and a column AD converter 45 applied to a solid-state imaging device according to the fifth embodiment of the present invention.

In FIG. 12, this solid-state imaging device includes the RTS noise reduction circuit 44 and the column AD converter 45 instead of the RTS noise reduction circuit 14 and the column AD converter 15 in FIG. 6. The RTS noise reduction circuit 44 is similar to the RTS noise reduction circuit 14 in FIG. 6 except that the switches SW4 and the capacitors C4 in FIG. 6 are omitted. Moreover, the column AD converter 45 is similar to the column AD converter 15 in FIG. 6. The capacitance value of the capacitor C1 can be made large compared to the configuration of FIG. 6 for reducing the KTC noise, and, for example, can be increased from 0.1 pF to 0.4 pF or more.

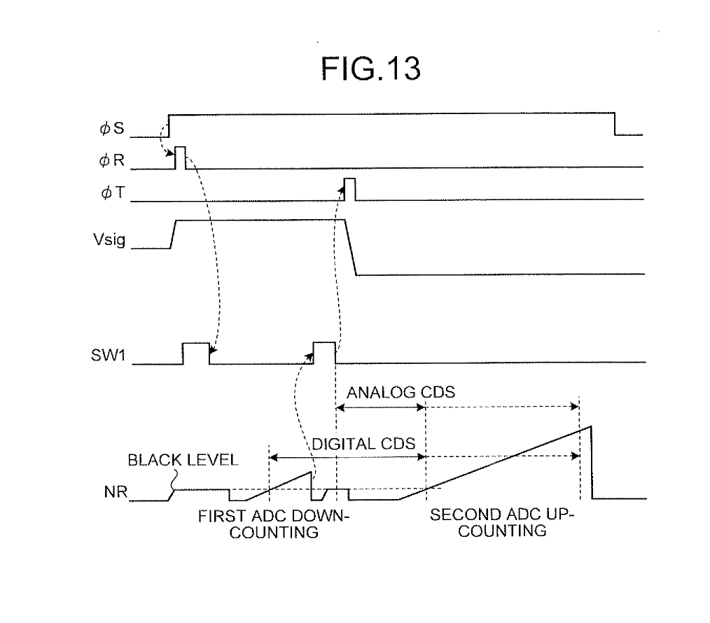

FIG. 13 is timing chart illustrating a signal waveform of each unit at the time of readout of the solid-state imaging device according to the fifth embodiment of the present invention.

In FIG. 13, in this fifth embodiment, the on/off operation of the switch SW1 is performed twice at the time when the row select signal ΦS is in a high level. The second on/off operation of the switch SW1 can be performed between the time after finishing the first operation of the up/down counter 6 and the time before the readout signal ΦT becomes a high level.

Then, the 1/f (RTS) noise of the source follower of the pixel PC is captured again in the capacitor C1 by the second on operation of the switch SW1 at the time when the row select signal ΦS is in a high level, and the reduction effect of the RTS noise equivalent to the third embodiment can be obtained. At this time, the signal waveform level of the reference signal NR is set to a black level (for example, 512 LSB at the operation of the ADC of 12 Bits) to become the same level as the time of capturing at the first on-time of the switch SW1 at the time when the row select signal ΦS is in a high level. The actual interval of the analog CDS is a period from the second off-time of the switch SW1 to the time when the output of the comparator AP2 is inverted in the second operation of the up/down counter 6 at the time when the row select signal ΦS is in a high level. In the period of low signal amount in which the RTS noise is noticeable, the CDS interval can be reduced to about ½ compared to the conventional method.

In the above embodiments, explanation is given for the method in which the column amplifier 3 is provided before the RTS noise reduction circuit 4, and the column amplifier 3 is provided for reducing the increase of the KTC noise due to the increase of the switching operation in the RTS noise reduction circuit 4. The generation amount of this KTC noise depends on the capacitance value of the capacitor C1. Therefore, if the capacitance value of the capacitor C1 is made sufficiently large, the column amplifier 3 can be omitted. In this case, the triangle wave of the reference signal NR can be generated to be on the negative side.

Moreover, in the above embodiments, the method is explained in which the down-counting is performed at a first time for converting a signal read out from the pixel PC into a digital value in the CDS to be held and the up-counting is performed at a second time to perform the differential process; however, it is applicable that the up-counting is performed at a first time to hold and the down-counting is performed a second time to perform the differential process.

Furthermore, in the above embodiments, explanation is made for the method in which the line memory 7 is provided for 1H after the up/down counter 6; however, it is applicable to provide the line memory for 2H, data subjected to the up-counting is held in the 1H-th line memory, data subjected to the up-counting or down-counting is held in the 2H-th line memory, and the subtraction process is performed at the time of reading out the output data Do to the outside.

In the above embodiments, explanation is made in which the pixel PC includes the row select transistor; however, it is possible to apply to the pixel PC that does not include the row select transistor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array unit in which pixels are arranged in a matrix manner;
a sample-and-hold signal conversion circuit that detects a signal component of each of the pixels in a correlated double sampling (CDS); and
a timing control circuit that controls to sample a reference level of an analog CDS after a reference level of a digital CDS is converted into a digital value.

2. The solid-state imaging device according to claim 1, further comprising a column amplifier that amplifies a signal read out from the pixel and outputs it to the sample-and-hold signal conversion circuit.

3. The solid-state imaging device according to claim 1, wherein
the sample-and-hold signal conversion circuit includes a first capacitor that holds the reference level of the digital CDS and the reference level of the analog CDS, and
the timing control circuit makes the first capacitor to hold the reference level of the digital CDS before the reference level of the digital CDS is converted into the digital value, and makes the first capacitor to hold the reference level of the analog CDS after the reference level of the digital CDS is converted into the digital value.

4. The solid-state imaging device according to claim 3, wherein the reference level of the analog CDS is set based on an output level of a comparator used in the digital CDS.

5. The solid-state imaging device according to claim 3, wherein the reference level of the analog CDS is set based on a clamp potential.

6. The solid-state imaging device according to claim 1, wherein
the sample-and-hold signal conversion circuit includes
a first capacitor that holds the reference level of the digital CDS and the reference level of the analog CDS, and
a first switch that averages the reference level held in the first capacitor between columns, and
the timing control circuit makes the first capacitor to hold the reference level of the digital CDS before the reference level of the digital CDS is converted into the digital value and makes the first capacitor to hold the reference level averaged between the columns as the reference level of the analog CDS after the reference level of the digital CDS is converted into the digital value.

7. The solid-state imaging device according to claim 3, wherein
the sample-and-hold signal conversion circuit includes
a second capacitor that holds the reference level of the digital CDS and the reference level of the analog CDS with a ground potential as a reference, and
a second switch that separates the first capacitor and the second capacitor from an upstream side of a vertical signal line that transmits a signal read out from the pixel, and
the timing control circuit makes the second capacitor to hold the reference level of the digital CDS before the reference level of the digital CDS is converted into the digital value, makes the second capacitor to hold the reference level of the analog CDS after the reference level of the digital CDS is converted into the digital value, and makes the second capacitor to hold a readout level of the analog CDS after readout of the signal from the pixel is started and makes the first capacitor and the second capacitor to be separated from the upstream side of the vertical signal line.

8. The solid-state imaging device according to claim 1, wherein the pixel includes
a photodiode that performs photoelectric conversion,
a reset transistor that resets a signal accumulated in a detection node;
a readout transistor that reads out a signal from the photodiode to the detection node, and
an amplifier transistor that amplifies the signal read out from the photodiode to the detection node.

9. The solid-state imaging device according to claim 8, wherein the sample-and-hold signal conversion circuit includes
an RTS noise reduction circuit that reduces an RTS noise superimposed on a readout signal from the pixel,
a column AD converter that compares the readout signal from the pixel with a reference signal, and
an up/down counter that calculates a difference between the reference level and a readout level of the CDS by performing an up-counting and a down-counting based on a comparison result of the column AD converter.

10. The solid-state imaging device according to claim 9, wherein
in the digital CDS, the reference level for comparing the signal read out from the pixel with the reference signal is set, and the reference level of the digital CDS is subtracted from the readout level of a signal component read out from the pixel, and
in the analog CDS, the reference level is set based on a signal in a reset level after the detection node of the pixel is reset, and the reference level of the analog CDS is subtracted from the readout level of the signal component read out from the pixel

11. The solid-state imaging device according to claim 9, wherein
the RTS noise reduction circuit includes
a first capacitor that holds the reference level of the digital CDS and the reference level of the analog CDS,
a first switch that averages the reference level held in the first capacitor between columns,
a second capacitor that holds the reference level of the digital CDS and the reference level of the analog CDS with a ground potential as a reference, and
a second switch that separates the first capacitor and the second capacitor from an upstream side of a vertical signal line that transmits a signal read out from the pixel.

12. The solid-state imaging device according to claim 11, wherein
the timing control circuit makes the first capacitor and the second capacitor to hold the reference level of the digital CDS before the reference level of the digital CDS is converted into the digital value, makes the first capacitor to hold the reference level averaged between the columns as the reference level of the analog CDS after the reference level of the digital CDS is converted into the digital value, makes the second capacitor to hold the reference level of the analog CDS after the reference level of the digital CDS is converted into the digital value, and makes the second capacitor to hold a readout level of the analog CDS after readout of the signal from the pixel is started and makes the first capacitor and the second capacitor to be separated from the upstream side of the vertical signal line.

13. The solid-state imaging device according to claim 9, wherein
the column AD converter includes a first switch that short-circuits an input and an output thereof, and
the RTS noise reduction circuit includes
a first capacitor that holds the reference level of the digital CDS and the reference level of the analog CDS,
a second capacitor that holds the reference level of the digital CDS and the reference level of the analog CDS with a ground potential as a reference, and
a second switch that separates the first capacitor and the second capacitor from an upstream side of a vertical signal line that transmits a signal read out from the pixel.

14. The solid-state imaging device according to claim 13, wherein the timing control circuit makes the first capacitor and the second capacitor to hold the reference level of the digital CDS before the reference level of the digital CDS is converted into the digital value, makes the first capacitor to hold a reference level when the input and the output of the column AD converter are short-circuited as the reference level of the analog CDS after the reference level of the digital CDS is converted into the digital value, makes the second capacitor to hold the reference level of the analog CDS after the reference level of the digital CDS is converted into the digital value, and makes the second capacitor to hold a readout level of the analog CDS after readout of the signal from the pixel is started and makes the first capacitor and the second capacitor to be separated from the upstream side of the vertical signal line.

15. The solid-state imaging device according to claim 9, wherein
the RTS noise reduction circuit includes
a capacitor that holds the reference level of the digital CDS and the reference level of the analog CDS, and
a switch that averages the reference level held in the first capacitor between columns.

16. The solid-state imaging device according to claim 15, wherein the timing control circuit makes the capacitor to hold the reference level of the digital CDS before the reference level of the digital CDS is converted into the digital value, and makes the capacitor to hold the reference level averaged between the columns as the reference level of the analog CDS after the reference level of the digital CDS is converted into the digital value.

17. The solid-state imaging device according to claim 9, wherein
the RTS noise reduction circuit includes
a capacitor that holds the reference level of the digital CDS and the reference level of the analog CDS, and
a switch that connects one end of the capacitor to a predetermined potential.

18. The solid-state imaging device according to claim 17, wherein the timing control circuit makes the capacitor to hold the reference level of the digital CDS before the reference level of the digital CDS is converted into the digital value, and makes the capacitor to hold a reference level obtained when the one end of the capacitor is connected to the predetermined potential as the reference level of the analog CDS after the reference level of the digital CDS is converted into the digital value.

19. The solid-state imaging device according to claim 9, wherein
the column AD converter includes a switch that short-circuits an input and an output thereof, and
the RTS noise reduction circuit includes a capacitor that holds the reference level of the digital CDS and the reference level of the analog CDS.

20. The solid-state imaging device according to claim 19, wherein the timing control circuit makes the capacitor to hold the reference level of the digital CDS before the reference level of the digital CDS is converted into the digital value, and makes the capacitor to hold a reference level when the input and the output of the column AD converter are short-circuited as the reference level of the analog CDS after the reference level of the digital CDS is converted into the digital value.
